(19) United States
(12) Patent Application Publication
(10) Pub. No.: US 2008/0049768 A1
(43) Pub. Date: Feb. 28, 2008

(54) DATA PROCESSING APPARATUS AND DATA SENDING/RECEIVING METHOD THEREOF

(75) Inventors: Bum-hee SEO, Seoul (KR); Chae-hwan Yang, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/744,408

(22) Filed: May 4, 2007

(30) Foreign Application Priority Data
Aug. 25, 2006 (KR) 2006-81059

(51) Int. Cl. H04L 12/28

(52) U.S. Cl. 370/401

(57) ABSTRACT

A data processing apparatus includes a wireless broadband module; a wireless local area network module; a wireless broadband module driver to drive the wireless broadband module; an antenna to communicate with an external device; a switch to connect/disconnect the antenna to/from the wireless broadband module and the wireless local area network module; and a controller to control the switch so that the antenna is connected with the wireless broadband module to communicate with the external device if the wireless broadband module driver is operating, and the antenna is connected with the wireless local network module to communicate with the external device if the wireless broadband module driver is not operating.

### CROSS-REFERENCE TO RELATED APPLICATIONS

This application claims all benefits accruing under 35 U.S.C. §119 from Korean Patent Application No. 2006-81059, filed on Aug. 25, 2006 in the Korean Intellectual Property Office, the disclosure of which is incorporated herein by reference.

### BACKGROUND OF THE INVENTION

1. Field of the Invention

Aspects of the present invention relate to a data processing apparatus and a data sending/receiving method thereof and, more particularly, to a data processing apparatus including a plurality of communicating modules which share an antenna and a data sending/receiving method thereof.

2. Related Art

Advances in communications technology have spurred development of various data communication standards. A wireless LAN (local area network) is a local area network which uses radio waves or infrared waves to transmit data, via mobile terminals, such as notebook computers, personal digital assistants, mobile phones, multifunction devices (smartphones), and the like. Communications modules with wireless LAN technology may send/receive data wirelessly at relatively low cost. However, wireless LANs may not be available when a mobile terminal is moving at high speeds or when a mobile terminal is out of range of an access point (AP).

To overcome the foregoing disadvantages of wireless LAN technology, wireless broadband (WiBro) modules have been developed that can access the Internet and can communicate while moving at high speeds. WiBro modules are more expensive that wireless LAN modules. However, the WiBro modules are popular since they have high data transmission rates, can send and receive data while the mobile terminal is moving at high speed, and have a larger range.

Regardless of the standard used, communications modules generally include an antenna to communicate with external devices. Wireless LAN modules and WiBro modules generally include both a main antenna and an auxiliary antenna. The modules can communicate data through the auxiliary antenna if the modules are not communicating data through the main antenna properly.

In an apparatus with both a WiBro module and a wireless LAN module, however, data may be sent and received through only one of them, and thus at any given point in time at least one antenna is not involved in sending/receiving data. Particularly, if each of the wireless LAN module and the WiBro module includes a main antenna and an auxiliary antenna, then at any given point in time, at least two antennas are not used to send or receive data. Thus, the antennas are not used efficiently.

### SUMMARY OF THE INVENTION

Accordingly, aspects of the present invention provide a data processing apparatus including both a WiBro module and a wireless LAN module which is capable of smoothly communicating with external devices and improving usage of an antenna by sharing the antenna installed in the WiBro module with other communications modules and a data sending/receiving method thereof.

Additional aspects and/or advantages of the invention will be set forth in part in the description which follows and, in part, will be obvious from the description, or may be learned by practice of the invention.

The foregoing and/or other aspects of the present invention are also achieved by providing a data processing apparatus comprising an antenna; a wireless broadband module to communicate with the external device, via the antenna; a wireless local area network module to communicate with the external device, via the antenna; a wireless broadband module driver to drive the wireless broadband module; a switch arranged to switch between one of the wireless broadband module and the wireless local area network module; and a controller to control the switch such that the antenna is connected with the wireless broadband module to communicate with the external device when the wireless broadband module driver is driven, and such that the antenna is connected with the wireless local network module communicate with the external device when the wireless broadband module driver is not driven.

The foregoing and/or other aspects of the present invention are also achieved by providing a wireless broadband module comprising an antenna; a data processing unit arranged to process data transmitted or received from an external device, via the antenna; and a switch to connect or disconnect the antenna to or from the data processing part and an external wireless local area network module.

The foregoing and/or other aspects of the present invention are also achieved by providing a data processing apparatus comprising a connecting unit to detachably couple a wireless broadband module and a wireless local area network module to the data processing apparatus; a wireless broadband module driver to drive the wireless broadband module, via the connecting unit; and a controller to control a switch installed in the wireless broadband module such that an antenna installed in the wireless broadband module is connected with the wireless broadband module to communicate with an external device when the wireless broadband module driver is driven and the antenna is connected with the wireless local network module to communicate with the external device when the wireless broadband module driver is not driven.

According to another aspect of the present invention, the wireless broadband module further comprises a wireless broadband antenna, and the controller measures data sending/receiving speeds of the antenna and the wireless broadband antenna and controls the wireless broadband module to communicate with the external device through the antenna having the higher data sending/receiving speed.

According to another aspect of the present invention, the wireless local area network module further comprises a wireless local area network antenna, and the controller measures data sending/receiving speeds of the antenna and the wireless local area network antenna and controls the wireless local area network module to communicate data through the antenna having the higher data sending/receiving speed.

According to the another aspect of the present invention, the data processing apparatus further comprises a user input unit to receive user input, wherein the controller controls the user input unit and the switch such that the antenna is connected to the wireless broadband module if the user inputs a command to drive the wireless broadband driver through the user input part.

According to another aspect of the present invention, the controller comprises an initialization routine performing unit to perform an initialization routine of the data processing apparatus and to determine, based on user input, whether to drive the wireless broadband module driver when performing the initialization routine.

According to another aspect of the present invention, the data processing apparatus further comprises an indication unit to display sending/receiving status of data in the wireless broadband module or in the wireless local area network module, wherein the controller controls the indication part to display the sending/receiving status of data in the wireless broadband module or in the wireless local area network module.

According to another aspect of the present invention, the data processing apparatus is a component of a portable computer.

According to another aspect of the present invention there is provided a data sending/receiving method of a data processing apparatus having an antenna to communicate with an external device, the method comprising: connecting a wireless local area network module and a wireless broadband module to the data processing apparatus; determining whether a wireless broadband module driver is driven to operate the wireless broadband module; and establishing communication with the external device, via the antenna, using the wireless broadband module when the wireless broadband module is driven.

According to another aspect of the present invention, the determining further comprises receiving an instruction by a user to drive the wireless broadband module driver and driving the wireless broadband module driver if the data processing apparatus receives the instruction.

In addition to the example embodiments and aspects as described above, further aspects and embodiments will be apparent by reference to the drawings and by study of the following descriptions.

### BRIEF DESCRIPTION OF THE DRAWINGS

A better understanding of the present invention will become apparent from the following detailed description of example embodiments and the claims when read in connection with the accompanying drawings, all forming a part of the disclosure of this invention. While the following written and illustrated disclosure focuses on disclosing example embodiments of the invention, it should be clearly understood that the same is by way of illustration and example only and that the invention is not limited thereto. The spirit and scope of the present invention are limited only by the terms of the appended claims. The following represents brief descriptions of the drawings, wherein:

FIG. 1 is a block diagram illustrating a configuration of a data processing apparatus according to a first example embodiment of the present invention;

FIG. 2 is block diagram illustrating a configuration of a data processing apparatus according to a second example embodiment of the present invention;

FIG. 3 is a block diagram illustrating a configuration of a WiBro module driver and a configuration of a WiBro module according to an example embodiment of the present invention;

FIGS. 4A and 4B are block diagrams illustrating operation of a switch based on the operation the WiBro module driver according to an example embodiment of the present invention; and

FIG. 5 is a flow chart illustrating operating processes of the data processing apparatus according to an example embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to like elements throughout. The embodiments are described below in order to explain the present invention by referring to the figures.

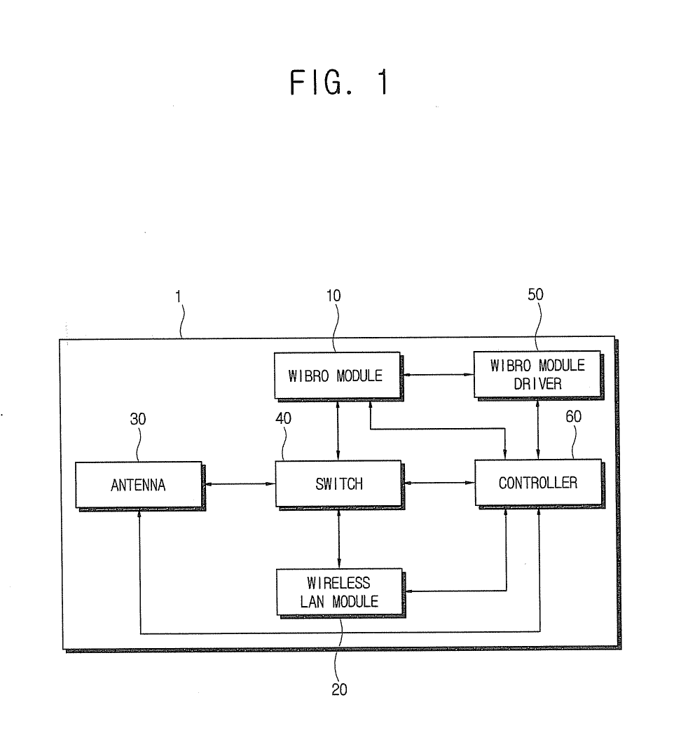

A data processing apparatus 1 according to a first example embodiment of the present invention will be described with reference to FIG. 1. A data processing apparatus 1 comprises a WiBro module 10, a wireless LAN module 20, an antenna 30, a switch 40, a WiBro module driver 50 and a controller 60. The data processing apparatus 1 is configured to receive data from an external device (not shown) and to process the data via predetermined applications. Such a data processing apparatus 1 may represent or may be a component of a mobile terminal, such as a notebook computer, a personal digital assistant (PDA), a mobile phone, a portable entertainment device, a multifunction device (such as a smartphone), etc.

The WiBro module 10 and the wireless LAN module 20 are communications modules that have different communication standards. The WiBro module 10 sends/receives data in the 2.3 GHz band and the wireless LAN module 20 sends/receives data in the 2.4 GHz band. The antenna 30 sends data from the WiBro module 10 and the wireless LAN module 20 to an external device or receives data from the external device.

The WiBro module 10 and the wireless LAN module 20 may each have a main antenna. In this case, the antenna 30 may be used as an auxiliary antenna for the WiBro module 10, if the WiBro module 10 needs to use the antenna 30. The antenna 30 may similarly be connected to the wireless LAN module 20 through the switch 40 to be used as an auxiliary antenna for the wireless LAN module 20, if the wireless LAN module 20 needs to use the antenna 30. The switch 40 connects the antenna 30 to the WiBro module 10 if the WiBro module driver 50 is operating and connects the antenna 30 to the wireless LAN module 20 if the WiBro module driver 50 is not operating, based on control by the controller 60.

The WiBro module driver 50 drives the WiBro module 10, and includes an application program interface (API) 50a, referred to as a WiBro connection manager (WCM) application, and a driver 50b including information on interfaces of the WiBro module 10 and the API 50a. The API 50a enables the WiBro module 10 to communicate with the external device and may drive the WiBro module 10 along with the driver 50b; a microcomputer; a memory, such as random access memory (RAM); etc.

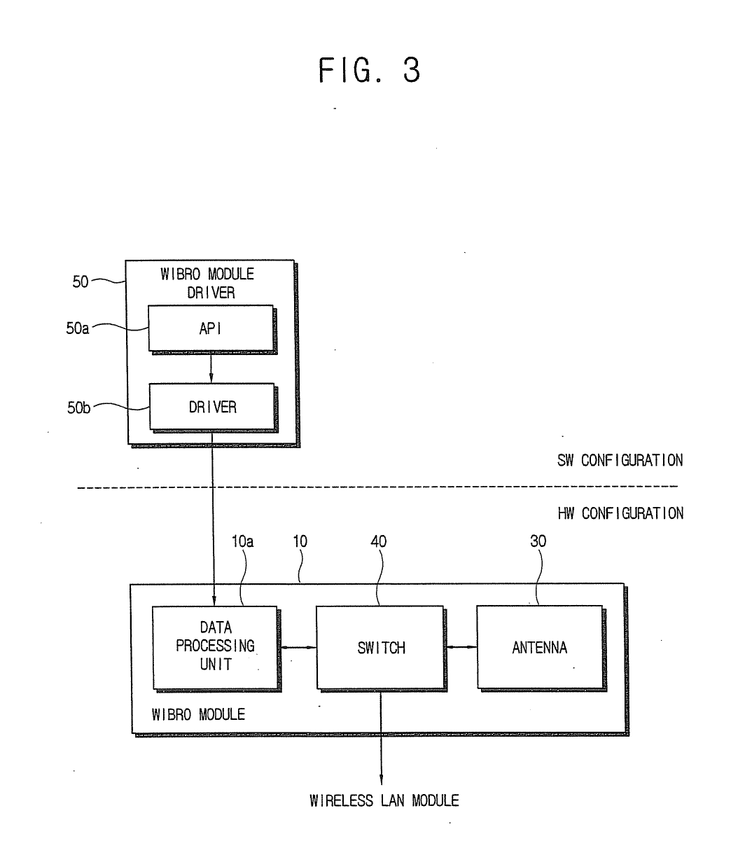

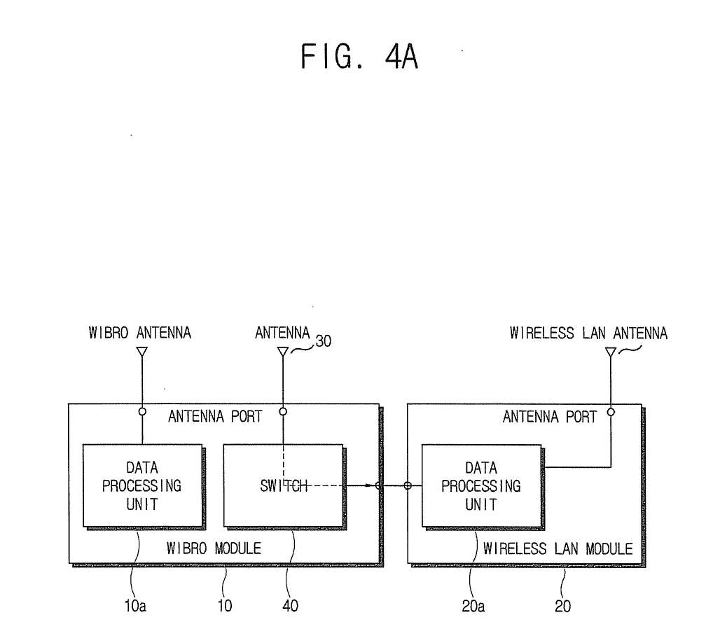

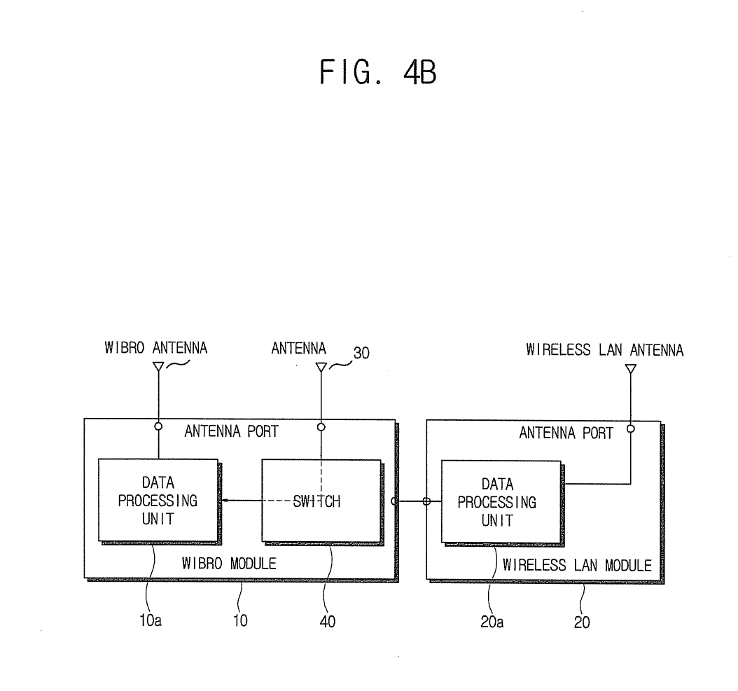

The WiBro module driver 50 determines whether the WiBro module 10 is able to communicate with the external device and delivers the result to the controller 60. If the WiBro module 10 is able to communicate with the external device, the controller 60 disconnects the antenna 30 from the wireless LAN module 20 and connects the antenna 30 to the WiBro module 10 so that the WiBro module 10 can communicate with the external device. Operations of the WiBro module driver 50 will de described later in detail with reference to FIGS. 3, 4A and 4B.

The controller 60 determines whether the WiBro module driver 50 is operating. If the WiBro module driver 50 is operating, the controller 60 controls the antenna 30 and the switch 40 so that the antenna 30 is connected to the WiBro module 10 to send/receive data. If the WiBro module driver 50 is not operating, the controller 60 controls the antenna 30 and the switch 40 so that the antenna 30 is connected to the wireless LAN module 20 to send/receive data.

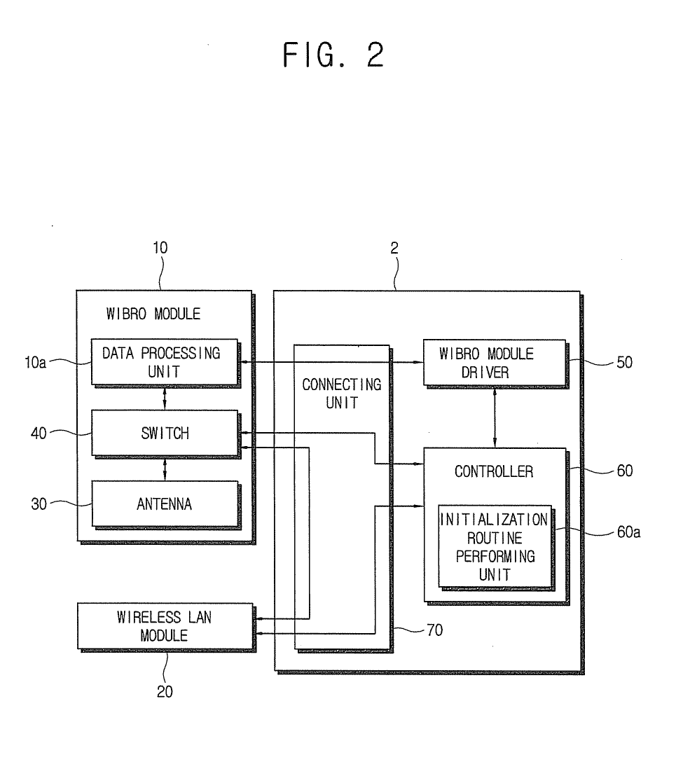

Turning now to FIG. 2, a data processing apparatus 2 according to a second embodiment of the present invention is illustrated. The data processing apparatus 2 includes similar components as shown in FIG. 1. However, a WiBro module 10 and a wireless LAN module 20 may be detachable from the data processing apparatus 2.40

As shown in FIG. 2, a data processing unit 10a, a switch 40, and an antenna 30 are disposed in the WiBro module 10. The data processing unit 10a communicates with an external device or processes signals in the data processing apparatus 2. The data processing unit 10a may include a Baseband integrated circuit (IC) and an RF IC to process data to be sent or received via the antenna 30. The switch 40 connects/disconnects the antenna 30 to/from the data processing unit 10a in the WiBro module 10 and the antenna 30 to/from a data processing unit 20a in a wireless LAN module 20 under control of a controller 60 (see FIGS. 4A and 4B). The switch 40 may be connected with the data processing unit 10a, via a general purpose input/output pin (GPIO). The antenna 30 enables the WiBro module 10 to communicate with the external device. The antenna 30 is connected to one of the data processing unit 10a in the WiBro module 10 and the data processing unit 20a in the wireless module 20, via the switch 40.

The controller 60 includes an initialization routine performing unit 60a configured to determine whether the WiBro module 10 or the wireless LAN module 20 is used when performing an initialization routine of the data processing apparatus 2. Such an initialization routine performing unit 60a may also be incorporated into the controller 60 of the data processing apparatus 1, shown in FIG. 1. For example, if the initialization routine performing unit 60a is a basic input output system (BIOS), a user may set one of communications modules in a BIOS setup stage during booting. Thus, during booting the data processing apparatus 1, as shown in FIG. 1, or the data processing apparatus 2, as shown in FIG. 2, one of the WiBro module 10 and the wireless LAN module 20 is connected to the antenna 30 to send/receive data.

A connecting unit 70 is included in the data processing apparatus 2 to enable the WiBro module 10 and the wireless LAN module 20 to attach thereto or detach therefrom. Such a connecting unit 70 delivers data received from the outside via an interface (such as PCI-Express or Universal Serial Bus) to the data processing apparatus 2 through the WiBro module 10 or through the wireless LAN module 20 and delivers data processed in the data processing apparatus 2 to the outside through the WiBro module 10 or through the wireless LAN module 20.

Since the connecting unit 70 includes the PCI-Express interface or the USB interface, a plug and play function is supported to use the communications modules without particular processes when connected with the communications modules. Thus, if one of the communications modules is turned on from an off state, information on the communications module is maintained, and thus the information on the communications module is not researched in the data processing apparatus 2.

The data processing apparatuses 1 and 2, as shown in FIGS. 1 and 2, may further include a user input unit (not shown) which is instructed by the user whether to operate the WiBro module 10. For example, if the WiBro module 10 is operated through the user input unit, the controller 60 controls the antenna 30 so that the WiBro module 10 can send/receive data in the data processing apparatus 1, where the WiBro module 10 or the wireless LAN module 20 is installed, or in the data processing apparatus 2, where the WiBro module 10 or the wireless LAN module 20 is connected. The user input unit may be a keyboard, a mouse, etc. A user interface (UI) may be displayed as a dialog box on a display (not shown) of the data processing apparatuses 1 and 2 for the user's input.

The data processing apparatuses 1 and 2 may further include an indication unit (not shown) to display sending/receiving status of data in the respective communications modules (the WiBro module 10 and the wireless LAN module 20). The user can view the sending/receiving status of the data in the communications modules through the display. If the data processing apparatuses 1 and 2 include both the WiBro module 10 and the wireless LAN module 20, the WiBro module 10 and the wireless LAN module 20 share the indication unit. The indication unit may be provided as a light emitting diode (LED) or other display device. The indication unit may also be implemented in software and appear on the display.

The data processing apparatuses 1 and 2 may further include a WiBro antenna through which the WiBro module 10 communicates with the external device and a wireless LAN antenna through which the wireless LAN module 20 communicates with the external device.

The antenna 30 may act as an auxiliary antenna for the WiBro module 10 and the wireless LAN module 20. The controller 60 may periodically measure data sending/receiving speeds of the WiBro antenna of the WiBro module 10, the wireless LAN antenna of the wireless LAN module 20, and the antenna 30 and sends/receives the data through the antenna having a higher speed.

Accordingly, the data processing apparatuses 1 and 2 may send/receive data efficiently and use the antenna 30 efficiently.

Configurations and operations of the WiBro module driver 50 and the WiBro module 10 according to example embodiments of the present invention will be described in detail with respect to FIGS. 3, 4A, and 4B.

FIG. 3 is a block diagram of an example WiBro module driver 50 and an example WiBro module 10. As shown in FIG. 3, the WiBro module driver 50 includes a WCM application (API) 50a and a driver 50b. The driver 50 is driven based on instructions received via the WCM application 50a. The instructions may originate from a user via the input part (not shown) or from another program.

If the WCM application is being used, the controller 60 controls the switch 40 so that the data processing unit 10a is connected to the antenna 30 to send/receive data. If the WCM application is not being used, the controller 60 controls the switch 40 to connect the antenna 30 with the wireless LAN module 20.

Operations of the switch 40 of the WiBro module 10 according to performance of the WiBro module driver 50 will be described in detail with respect to FIGS. 4A and 4B. Here, the notification of the data processing unit 10a of the WiBro module 10 is the same as in FIG. 3.

FIG. 4A illustrates operation of the switch 40 if the WiBro module driver 50 is not being used. If the WiBro module driver 50 is not being used, the controller 60 controls the switch 40 so that the antenna 30 is disconnected from the data processing unit 10a of the WiBro module 10 and is connected to the data processing unit 20a of the wireless LAN module 20. Thus, the wireless LAN antenna of the wireless LAN module 20 functions as a main antenna and the antenna 30 functions as an auxiliary antenna for the wireless LAN module 20.

FIG. 4B illustrates operation of the switch 40 if the WiBro module driver 50 is being used. If the WiBro module driver 50 is being used, the controller 60 controls the switch 40 so that the antenna 30 is disconnected from the data processing unit 20a of the wireless LAN module 20 and is connected to the data processing unit 10a of the WiBro module 10. Thus, the WiBro antenna of the WiBro module 10 functions as a main antenna for the WiBro module 10 and the antenna 30 functions as an auxiliary antenna for the WiBro module 10.

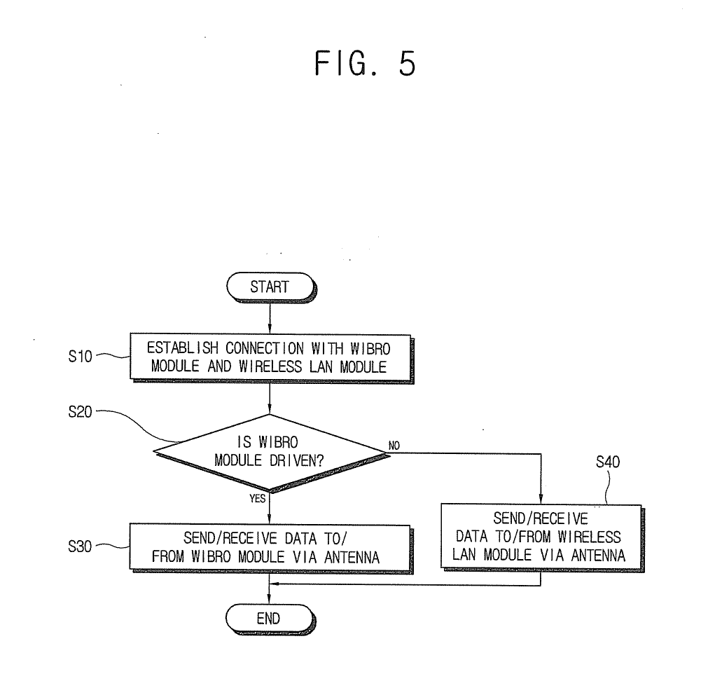

A data sending/receiving technique of the data processing apparatuses 1 or 2 will be described with reference to FIG. 5. For the purpose of convenience the technique will be described with reference to data processing apparatus 1, as shown in FIG. 1; however, the same technique may apply equally to data processing apparatus 2, as shown in FIG. 2, or to any other embodiment of the present invention.

The controller 60 determines whether the WiBro module 10 and the wireless LAN module 20 are connected to the data processing apparatus 1 at block S10. If the Wibro module 10 and the wireless LAN module 20 are connected to the data processing apparatuses 1, the controller 60 determines whether the WiBro module driver 50 is operating at block S20. If the WiBro module driver 50 is being driven, the controller 60 controls the switch 40 so that the WiBro module 10 communicates with the external device through the antenna 30 at block S30. If the WiBro module driver 50 is not being driven, the controller 60 controls the switch 40 so that the wireless LAN module 20 communicates with the external device through the antenna 30 at block S40. The antenna 30, which communicates the external device, may be installed in the WiBro module 10, as shown in FIG. 2.

At block S20, the user may instruct the controller 60 to operate the WiBro module driver 50. If the WiBro module driver 50 is operated according to the user's instruction, the controller 60 controls the switch 40 so that the WiBro module 10 communicates with the external device. If the WiBro module driver 50 is not operated, the controller 60 controls the switch 40 so that the wireless LAN module 20 communicates with the external device.

As described above, a data processing apparatus according to aspects of the present invention is capable of smoothly communicating with external devices and improving usage of an antenna by sharing the antenna installed in a WiBro module with other communications modules.

While there have been illustrated and described what are considered to be example embodiments of the present invention, it will be understood by those skilled in the art and as technology develops that various changes and modifications, may be made, and equivalents may be substituted for elements thereof without departing from the true scope of the present invention. Many modifications, permutations, additions and sub-combinations may be made to adapt the teachings of the present invention to a particular situation without departing from the scope thereof. For example, the WiBro module and the wireless LAN module may communicate using any wireless technology, such as Bluetooth. Further, aspects of the invention may include a computer readable medium having instructions which, when performed by a processor, cause the processor to connect the WiBro module and/or the wireless LAN module to the antenna according to aspects of the present invention. Accordingly, it is intended, therefore, that the present invention not be limited to the various example embodiments disclosed, but that the present invention includes all embodiments falling within the scope of the appended claims.

What is claimed is:

1. A data processing apparatus comprising:
an antenna;
a wireless broadband module to communicate with an external device, via the antenna;
a wireless local area network module to communicate with the external device, via the antenna;
a wireless broadband module driver to drive the wireless broadband module;
a switch arranged to switch between one of the wireless broadband module and the wireless local area network module; and
a controller to control the switch such that the antenna is connected with the wireless broadband module to communicate with the external device when the wireless broadband module driver is driven and such that the antenna is connected with the wireless local network module to communicate with the external device when the wireless broadband module driver is not driven.

2. A wireless broadband module comprising:
an antenna;
a data processing unit arranged to process data transmitted or received from an external device, via the antenna; and
a switch to connect or disconnect the antenna to or from the data processing unit and an external wireless local area network module.

3. The data processing apparatus according to claim 1, wherein:
the wireless broadband module further comprises a wireless broadband antenna, and
the controller measures data sending/receiving speeds of the antenna and the wireless broadband antenna and controls the wireless broadband module to communicate with the external device through the antenna having the higher data sending/receiving speed.

4. The data processing apparatus according to claim 3, wherein:
the wireless local area network module further comprises a wireless local area network antenna, and
the controller measures data sending/receiving speeds of the antenna and the wireless local area network antenna and controls the wireless local area network module to communicate with the external device through the antenna having the higher data sending/receiving speed.

5. The data processing apparatus according to claim 1, further comprising:
a user input unit to receive user input;
wherein the controller controls the user input unit and the switch so that the antenna is connected to the wireless broadband module if the user inputs a command to drive the wireless broadband driver through the user input unit.

6. The data processing apparatus according to claim 1, wherein the controller comprises a initialization routine performing unit to perform an initialization routine of the data processing apparatus and determines, based on user input, whether to drive the wireless broadband module driver when performing the initialization routine.

7. The data processing apparatus according to claim 1, further comprising:
an indication unit to display sending/receiving status of data in the wireless broadband module or in the wireless local area network;
wherein the controller controls the indication unit to display the sending/receiving states of data in the wireless broadband module or in the wireless local area network.

8. The data processing apparatus according to claim 1, wherein the data processing apparatus is a portable computer.

9. A data sending/receiving method of a data processing apparatus having an antenna to communicate with an external device, the method comprising:
connecting a wireless local area network module and a wireless broadband module to the data processing apparatus;
determining whether a wireless broadband module driver is driven to operate the wireless broadband module is; and
establishing communication with the external device, via the antenna, using the wireless broadband module when the wireless broadband module driver is driven.

10. The data sending/receiving method of the data processing apparatus according to claim 9, wherein the determining further comprises:
receiving an instruction by a user to drive the wireless broadband module driver; and
driving the wireless broadband module driver if the data processing apparatus receives the instruction.

11. The data sending/receiving method of the data processing apparatus according to claim 9, wherein the data processing apparatus is a component of a portable computer.

12. A mobile device having a wireless broadband module and a wireless local area network (LAN) module, the mobile device comprising:
an antenna; and
a controller arranged to establish communication with an external device between one of the wireless broadband module and the wireless LAN module, via the antenna, based on an instruction.

13. The mobile device of claim 12, further comprising a switch to connect one of the wireless broadband module and the wireless local area network module to the antenna.

14. The mobile device according to claim 12, further comprising:
a connector to couple the wireless broadband module and the wireless local area network module to the mobile device so that the wireless broadband module and the wireless local area network module may be detached from the mobile device.

15. The mobile device according to claim 12, wherein the antenna is disposed within the wireless broadband module.
